(19) United States
(12) Patent Application Publication
(10) Pub. No.: US 2003/0108849 A1
(43) Pub. Date: Jun. 12, 2003

(54) Method of grouping patient information

(76) Inventor: Vannie Kay Hodges, Ann Arbor, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/016,389

(22) Filed: Dec. 10, 2001

(51) Int. Cl. G09B 19/00

(52) U.S. Cl. 434/236

(57) ABSTRACT

A method for evaluating the scores from CAFAS evaluations includes the use of a flowchart for evaluating the various scores in a series of steps. In particular, a hierarchy for the various scales is set, and the flowchart moves through that hierarchy. If the hierarchy of scales has a score above a predetermined value, and in particular typically a moderate or severe score, then the patient is grouped into a tier associated with that particular scale being high.

### BACKGROUND OF THE INVENTION

This invention relates to a method and system for making predictions about a particular patient based upon data gathered on various aspects of the patient's personality. Typically, the patient is a youth.

One common method of assessing the mental health or personality of a child or adolescent is the so-called Child and Adolescent Functional Assessment Scale (CAFAS). This test involves a number of questions which are asked about an individual in eight different categories. The test is the copyrighted property of K. Hodges, Ph.D., the inventor of the present application. A portion of one of the scales is reproduced as FIG. 1. A copy of a complete CAFAS® test is included in the file history of this patent application. Essentially, a rater asks questions about the patient through an interview with an individual who might have better knowledge such as a caregiver. Often, the complete evaluation of a patient and the treatment of the patient will include several individuals. There may be an informer, who may be a caregiver or may be associated with the school and identify certain information with regard to the patient. The rater typically asks questions of the informer to obtain the information needed to complete (rate) the CAFAS®, After studying the answers, the rater completes the CAFAS® and makes judgments as to potential treatment, and may sometimes ask the questions of the informer. Typically, the term “rater” as utilized in this field of art, would include the person who then handles the patient's treatment. Among the people who may be involved in any of the several above-defined roles are clinicians, teachers, staff from juvenile justice offices, staff from child protective care or child welfare agencies, parents, or other people who may be involved with the patient. For purposes of this application, each of these several roles can be performed by various individuals as the point of this invention does not relate to how any particular piece of the information coming together is achieved. Instead, this invention relates to how the information is evaluated once the basic information has been gathered.

Once the answer to a particular behavior is determined to be true, the patient is identified as being within that level of impairment. Thus, as shown in FIG. 1 at 20, there are a series of behaviors in the severe impairment column 22, other behaviors in the moderate impairment column 24, other behaviors in the mild impairment column 26, and other behaviors in the minimal or no impairment column 28. The caregiver would start with the severe impairment. If the answer is true to any of the severe impairment behaviors, then that patient is given a ranking of severe impairment for that particular scale. If none of the severe impairment behaviors are answered true, the caregiver then moves to the moderate impairment, mild impairment and then minimal or no impairment column. The above is all as known.

Eventually, the patient has been evaluated in each of the eight scales shown in the FIG. 2 score chart. While only eight scales are shown, it is certainly possible that other numbers of scales can be utilized. The categories 30, 32, 34, 36, 38, 40, 42 and 44 each include a ranking for the patient in each scale or category of severe, moderate, mild or minimal-no impairment. As can also be seen, each of the rankings or levels carry a point value.

To date, the point value for the patient in each of the several fields is stored and utilized in evaluating the patient. While the CAFAS test has proven to be very successful, it would be beneficial to be able to make predictions about a particular patient based upon the test scores.

### SUMMARY OF THE INVENTION

In the disclosed embodiment of this invention, a method of analyzing the test scores in each of the several scales allows a rater to make a prediction of the type of treatment that will probably be necessary for the particular patient. The scales are ranked, and a computer program or a rater walks through the scores utilizing a flowchart type approach to reach predictions about the particular patient.

The flowchart looks at the level of impairment (or point value) in a hierarchy of scales, and then categorizes the patient into any one of several groups based upon the flowchart.

While a preferred flowchart is disclosed, it should be understood that other flowcharts, and other groupings would come within the scope of this invention. It is the utilization of the information from the chart of FIG. 2, or from some other source, to group a patient into any one of several predictive groups which is inventive here.

In particular, in a method according to this invention, a youth is first ranked into the scales of school/work, home role, community role, behavior towards others, mood/emotions, self-harmful behavior, substance use, and thinking.

The hierarchy of these scales is preferably that thinking is selected as the most primary scale in being able to make predictions or groupings about the patient. If the thinking scale is high (as an example, severe or moderate), then the patient is grouped into the thinking tier or group. If instead, the thinking scale is low (mild or minimal), then the flowchart next looks at the substance use category. If the substance use category is high (severe or moderate), then the patient is grouped into the substance use tier or group. If substance use is also low, then the flowchart next looks at both the self-harmful and mood/emotion scores. If these are both high, then the patient is grouped into the self-harm tier or group. In the most preferred embodiment of this invention, the categorization in the self-harm tier would only occur when the self-harmful group score is severe or moderate. The mood/emotion would only move towards categorization in the self-harmful tier if the mood/emotion was severe.

If both self-harm and mood are low, the method next looks at the community score. If the community score is severe or moderate, then the youth is grouped into the uncomplicated delinquent tier.

If community score is mild or minimal, the flowchart next looks at school, home and behavior towards others. If any one of these three is severe or moderate, then the flowchart next looks at the mood score. If the mood score is moderate, then the youth is grouped into the behavior group with mood issues tier. If mood is not moderate, then the youth is grouped into the behavior without mood issues tier.

If school, home and behaviors towards others are all mild or minimal, then the flowchart next asks whether the total score is greater than zero. Essentially, this would ask whether all of the scales resulted in a minimal or no ranking. If the total score is greater than zero, the youth is then ranked into the adjusted with impairment tier. If the total score is not greater than zero, then the youth is placed into a not impaired tier.

Further, as to the required treatment, another level of inquiry can occur once the particular tier has been identified for the particular patient. A “support” scale can also be identified by looking at the family support structure for the home in which the patient resides, and the material needs (costs, necessary support structure, intensity of recommended care, etc.) for the patient. If the particular home is such that the support structure or financial abilities necessary for caring for the individual patient is not met by the family/home, then more intensive support for the patient (in the way of services to the family/caregivers) may be in order. However, if the home would appear to be able to meet the patient's needs, then perhaps less intensive treatment may be indicated. Once each of the groups, as set forth above, are identified, this question can then be asked to resolve any final recommendation for the patient.

Again, the specific flow and steps may differ while still coming within the scope of this invention. The method is preferably realized through a computer software program, however, it could also take the form of written instructions for evaluation of the scale data.

These and other features of the present invention can be best understood from the following specification and drawings, the following of which is a brief description.

### BRIEF DESCRIPTION OF THE DRAWINGS

FIG. 1 shows a portion of a CAFAS scale form.

FIG. 2 shows the CAFAS profile.

FIG. 3 shows a flowchart of the present invention.

FIG. 4 shows a hard copy alternative.

FIG. 5 shows a first additional feature.

FIG. 6 shows an alternative of the flowchart of FIG. 3.

### DETAILED DESCRIPTION OF A PREFERRED EMBODIMENT

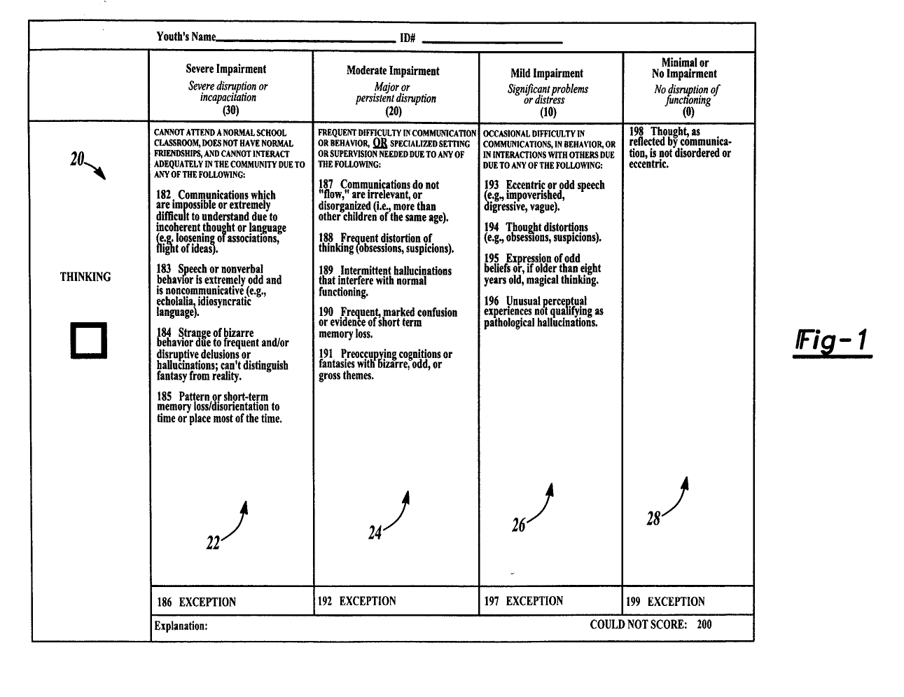

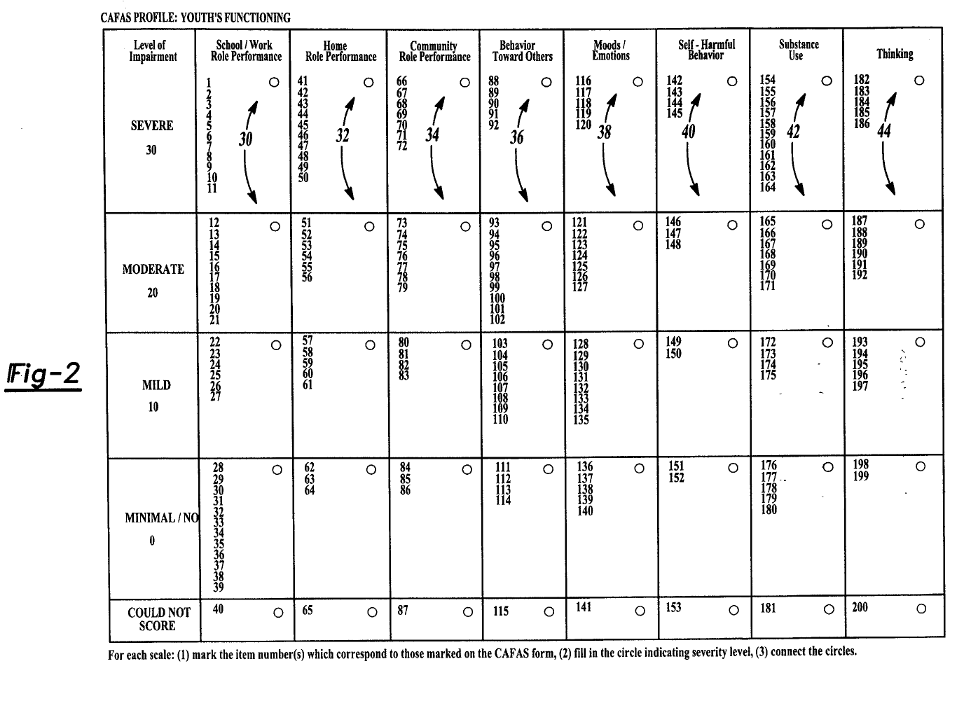

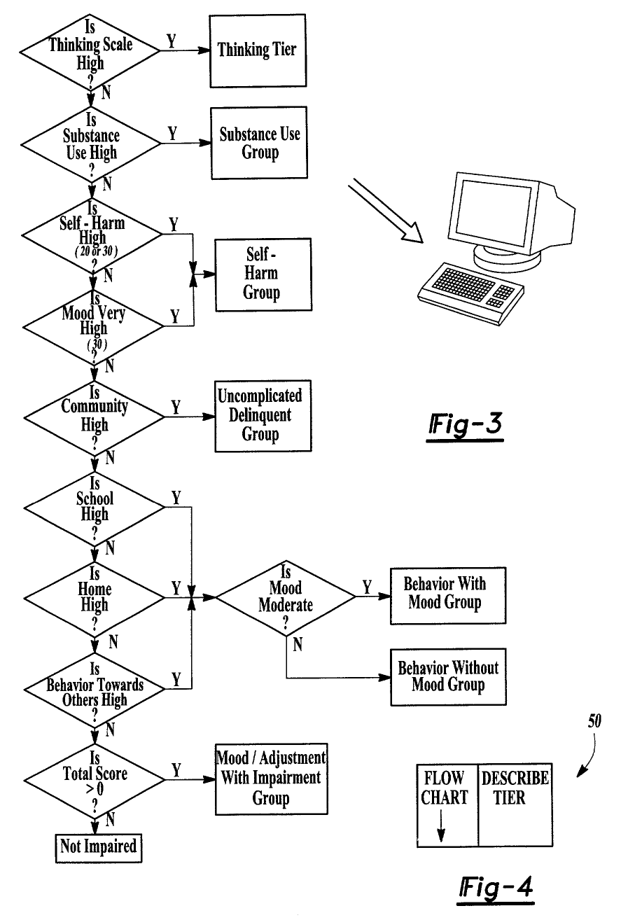

The charts of FIGS. 1 and 2 have been described above. Once the information gathered in the chart of FIG. 2 has been completed, the information is then entered into the computer 48. The computer 48 is preferably provided with a software program as explained in the flowchart of FIG. 3. Alternatively, as is shown in FIG. 4, a written evaluation document 50 could also be prepared which provides this method in the form of the flowchart with explanations of each tier.

Further, the written material 50 as shown in FIG. 4, or the computer 48 as shown in FIG. 2, will each preferably include information about the various tier types which are the end result of the method of this invention. Thus, one utilizing this method would not only rank a patient into a particular tier, but then would have information that would assist in prescribing or predicting the treatment necessary for a particular patient.

Of course, while the questions in the flowchart simplify the question down to whether the particular rating is “high”, other methods of achieving the answer to these various questions can be achieved. The particular items as set forth in Level I which would result in the “high” ratings could instead be simply entered into the questioning. As an example, the question could instead be “is the answer to any of questions 182-191, yes?” If so, then the flowchart can flow as shown.

As shown in FIG. 3, in effecting this method, a hierarchy of the scales as shown in FIG. 2 are utilized. The thinking scale has been identified as the highest hierarchy. A youth with problems on the thinking scale could be grouped into the thinking tier. The thinking tier could be described as follows:

### Thinking Client Type

These youths have a thought disorder or have poor communication, hallucinations, marked confusion, or bizarre, odd preoccupying cognitions which are severe enough to, at minimum, cause difficulty in relating to others. These youth typically require a specialized setting or close supervision.

Youths in the “Thinking” group most likely need more diagnostic work to confirm whether they have thinking and/or major communication difficulties. The first task is to verify that the youth's score on the Thinking scale is accurate (i.e., severe or moderate impairment is present).

Youths who are misinterpreting their environment in major ways can be at risk for hurting themselves or others because of their confusion or misunderstandings.

If the youth is comorbid (i.e., having other co-occurring psychiatric disorders), it is critical to consider the relationship of their thinking impairment to other problems.

The diagnoses for these youth may include, but would not be limited to: autism, pervasive development disorder, schizophrenia, schizotypal, brief psychotic episode, obsessive-compulsive disorder, eating disorder, bipolar depression, and severe post-traumatic stress disorder.

Treatment usually includes care by a psychiatrist, at least initially, and long-term availability of services. Psychotropic medication is often included in the protocol.

If the thinking scale is indicative of lower impairment, then the method next would look at the substance use score. If the substance use score is high, then the youth is categorized into the substance use tier. The substance use tier could be described as follows:

### Substance Use Client Type

These youths have negative consequences or effects on themselves or others due to alcohol or other drug usage. This is in the context of no thought disorder or thinking problems (since the youth did not meet the criteria for the “Thinking” CAFAS client type).

It is important to determine whether the treatment will be sequential or integrated and whether the provider will be a specialist or a generalist.

Since having a comorbid condition which includes Substance Use is a risk factor for treatment drop out and for unfavorable treatment outcome, close tracking of these at-risk youths from an administrative perspective would be important.

Youths in this subgroup who have had previous treatment for substance use problems are likely to consume a disproportionate amount of the funds available for services, indicating another reason for administrative oversight of the services offered to these youths.

Substance use is a risk factor for suicide, providing another reason for tracking these youths.

If substance use is also low, then the flowchart looks at both the self-harm and the mood/emotions categories. If either of these is high, then the youth is categorized into the self-harm group. Notably, in a preferred embodiment it is only when mood/emotions is severe that a mood score would move the youth into the self-harm tier. A self-harm type patient could be described as below:

### Self-Harmful Potential Client Type

These youths have suicide intent (i.e., want to die), have made a suicide attempt, have a suicide plan, have engaged in non-accidental self-harming behavior, or have repeatedly talked about dying; or these youths are severely depressed to such an extent that they are impaired in everyday functioning. This is in the context of not having a thought disorder and no known substance use problems.

Identification of these youths on first clinical contact is important for evaluating their risk and promptly implementing a treatment of sufficient strength.

This type includes youths rated as severely impaired on the Self-Harmful scale as well as youths who are rated as severely impaired on the Moods/Emotions scale, irrespective of their score on the Self-Harmful scale. Thus, the label for this group includes the term “Potential,” referring to the potential to be self-harmful, not documented risk. The rationale for including youths who are rated as severe on the Mood/Emotions scale is to be conservative about identifying youth who may be at risk for self-harm, since interviewers may not be experienced at getting youths to articulate their feelings and some depressed youths may not be aware of or able to communicate their suicidal tendencies.

Youths can present as self-harmful in the absence of depression, and thus, can be rated as moderately or severely impaired on the Self-Harmful Behavior scale even if the Moods/Emotions scale is scored as no impairment.

If both self-harm and mood are low, then the flowchart next will consider the community score. If the community is score is severe or moderate, then the youth is identified as being an uncomplicated delinquent. This group could be described as follows:

### Delinquent Client Type

These youths have gotten in trouble with the law or there is substantial reason to believe that they have seriously or repeatedly violated the law, despite not having gotten into trouble yet.

A youth would be in this group if the youth were not severely or moderately impaired due to thought problems, substance use, or self-harmful potential, but is rated on the Community scale at the severe or moderate level. Thus, these youths are not comorbid for severe depression or substance use, both of which are common co-occurring disorders for conduct disordered youths. In this regard, these youths could be viewed as “uncomplicated” delinquents.

The natural course of events for these youths indicates a very poor prognosis in general. More specifically, there is compelling data indicating that aggressive behaviors is a very stable characteristic, especially if the onset is before adolescence. These youths are also likely to drop out of treatment.

Despite the poor prognosis in general for these youths, recent studies have demonstrated treatment effectiveness. A recent review of the literature concludes that the only outpatient treatments that have demonstrated efficacy or probable efficacy in treating conduct disorder are behavioral and cognitive behavioral treatments (Kazdin, 1998). In the literature on treatment of delinquency, there is evidence of the effectiveness of multisystemic therapy (MSF: Henggeler, Schoenwald, Borduin, Rowland & Cunningham, 1998) and therapeutic foster care (Chamberlain & Reid, 1998). Furthermore, there is compelling research evidence indicating that treatment of these youths in group settings (with other deviant youths) actually exacerbates the disorder (Dishion, McCord & Poulin, 1999). These data could make a case against treatment in residential treatment centers and group homes, which is alarming, given that this is the typical treatment.

From a clinical and administrative perspective, it would be important to identify these youths at entry into the system and funnel them to services other than traditional mental health treatments which continue to be used in traditional settings (e.g., individual insight therapy, group treatment, residential and other delinquents). It would seem important to begin the treatments that have demonstrated effectiveness as early as possible in the treatment process so as to hopefully minimize dropouts.

If the community score is also low, then the flowchart looks at the school, home and behavior towards others scores. If all three of these are low, then the flowchart looks at the total score for all eight of the scales. If all eight of the scales have resulted in a zero score, the youth is tiered as not impaired. However, if any one of the school, home or behavior towards others scales results in a moderate or severe ranking, then the scale looks at the mood score. If the mood score is moderate (a severe mood scale would have resulted in the youth being earlier tiered), then the youth is tiered into a group or tier called behavior disorders with mood disturbance. This group could be described as follows:

### Behavior Disorders with Mood Disturbance

These youths have behavioral problems at school and/or in the home or residence where they live, and/or have poor interpersonal relationships with other youths or adults. In addition, these youth are experiencing anxiety or depression which is not severe, but which has a negative effect on their functioning. This is in the context of the absence of: thought disorder, substance use problems, severe depression, self-harmful behavior, involvement with the legal system, or recent violation of the law.

If the mood score is not moderate, but is instead mild or minimal, then the youth is categorized as behavior disorders without mood disturbance. This group could be described as follows:

### Behavior Disorders Without Mood Disturbance

These youths have behavioral problems at school and/or in the home/residence where they live, or/and have poor interpersonal relationships with other youths or adults. There is a notable absence of anxiety or depression. This is in the context of the absence of: thought disorder, substance use problems, severe depression, self-harmful behavior, involvement with the legal system, and known recent violation of the law.

Youths in these two Behavior Disorder groups are characterized by disruptive behavior, with many youths diagnosed with attention deficit-hyperactivity disorder or oppositional defiant disorder. However, youths with a variety of disorders can demonstrate these types of behavioral problems. Conduct disordered youths with no delinquent behavior would also be included in this group.

Well-established and probably efficacious treatments for disruptive disorders in general tend to be behavioral or cognitive behavioral in orientation and emphasize parent training (Kazdin, 1998). However, cognitive behavioral treatments have no known efficacy with attention deficit-hyperactivity disorder (ADHD: Burns, Hoagwood & Mrazek, 1999). Recent results from the NIMH Multimodal Treatment Study of ADHD indicate that medication is effective in reducing core symptoms of ADHD (i.e., inattention, hyperactivity, or impulsivity). Furthermore, combination treatment which included behavioral interventions and medication was superior in reducing problems which often accompany symptoms of ADHD, such as oppositional/aggressive symptoms, internalizing symptoms, parent-child relations, and reading achievement (Burns, Hoagwood &Mrazek, 1999).

If the result of the school, home and behavior question is that none of those categories have moderate or severe rankings, but the total score is greater than zero, then the youth is categorized as “mood/adjustment problems with impairment”. This group can be described as follows:

### Mood/Adjustment Problems with Impairment

For the youths who have no more than mild problems in any domain of functioning, a variety of prevention programs are available (see Burns, Hoagwood & Mrazek, 1999 for a review).

For youths with moderate impairment in mood (in the absence of impairing disruptive behavior problems), there is support for a number of interventions (Burns, Hoagwood & Mrazek, 1999). Cognitive behavior therapy has been shown to be efficacious with preadolescents (Stark, Rouse & Livingston). In Burns, et al.'s (1999) review, interpersonal therapy (Mufson, Moreau, Weissman, Wickramaratne, & Samoilou, 1999; Mufson, Weissman, Moreau & Garfinkel, 1999) and multi-systemic family therapy are described as promising practices. Bums, et al. (1999) also point out that studies conducted on the efficacy of tricyclic antidepressants fail to support therapeutic effects relative to placebo, although there is some preliminary data pointing to the potential effectiveness of selective serotonin re-uptake inhibitions (SSRIs).

The written materials which are to be prepared, along with the categorization of the various tiers as described above, are all the copyright property of K. Hodges, Ph.D. However, the functional grouping of patients into any of several categories based upon this type of data is a patentable and beneficial utilization of the previously known scale rankings.

FIG. 5 shows another level that can be utilized once particular groups or tiers are identified to categorize the recommended type of treatment for each of the patients. The status of the home or family for the patient is evaluated to determine whether the family provides adequate support for the patient, as would be indicated by the patient's particular type of problem, and whether the patient's needs (financial support, family support, etc.) can be met by the patient's particular family/home environment. The particular required combination of the family/school support, and material needs necessary, can vary not only between the tiers, but actually can also vary within each of the tiers. As an example, there may be individuals within the “thinking tier” which might require a lower material (financial) support than others. These additional factors can then be taken to recommend whether intensive family support is necessary, or whether a less intensive treatment may be adequate for the particular patient.

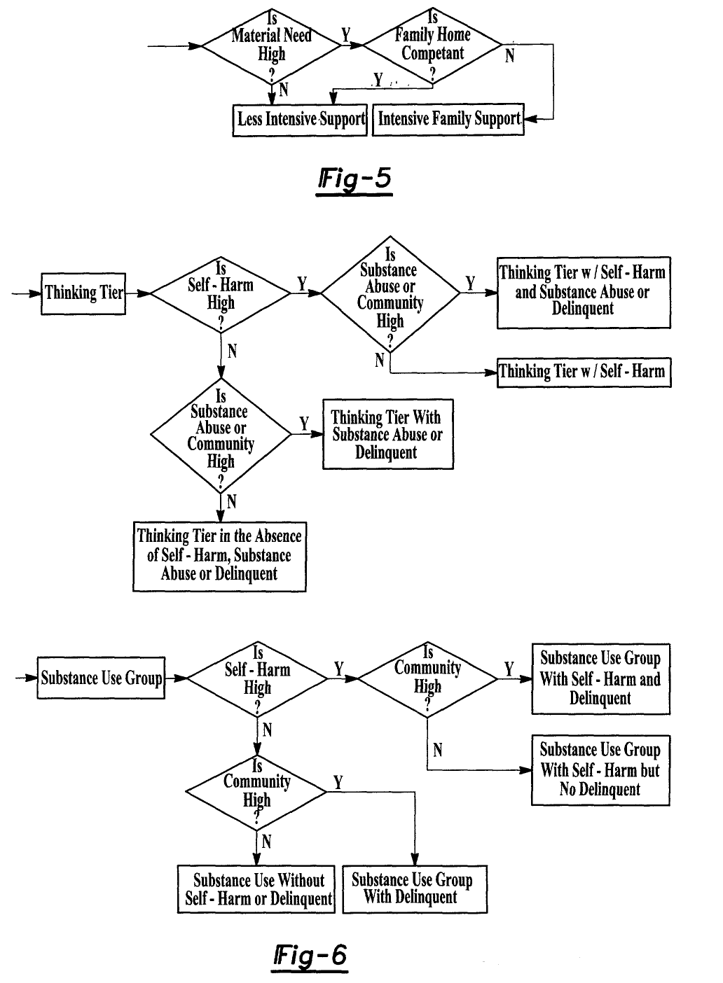

Further, FIG. 6 shows a much more detailed flowchart for an alternative embodiment. The basic structure of the method for developing the ranking is the same, however, there are additional groupings, and additional questions as set forth in FIG. 6.

As can be seen from FIG. 6, the grouping of the patient into at least the highest groups or tiers (i.e., Thinking and Substance Use in the illustrated embodiments) further breaks down into levels of groupings within that tier based upon the answer to the questions that are lower on the hierarchy. Thus, as can be appreciated from the FIG. 6 example, once a patient may be grouped into the Thinking tier, there are four additional groupings that could be used by performing additional evaluations with regard to the Self-Harm, Substance Abuse and Community scales. Each of these four groups may have somewhat different recommended treatment. A similar example is shown with regard to patients initially grouped into the Substance Use group.

Of course many other permutations of the analysis of the information to result in groupings are possible. As examples, a patient could be grouped into a Pervasive Behavior Problem with Mood Disturbance group if the school, home, behavior towards others and mood scales are all high. A patient could be grouped into the Cross-Situational Behavior Problems With Mood if the mood scale and any two of school, home or behavior towards others are high. Another group would be School Problems With Mood if the school and mood are high, but home is not high. The patient could be Home Problems With Mood if the home and mood are high, but the school is not high. The patient could be ranked as Pervasive Behavior Problems Without Mood Disturbance if school, home and behavior towards others are all high. The patient could be grouped as Cross-Situational Behavior Problems Without Mood if any two of school, home or behavior towards others are high. The patient could be grouped as School Problems Without Mood if school is high but home is not high. The patient could be grouped as Home Problems Without Mood if home is high but school is not high. The patient could be grouped as Moods without any behavioral problems if the mood is above an intermediate level, but school, home and behavior towards others are all low or zero.

For purposes of the claims in this case, the terms of the various tiers or groups are merely exemplary. Also, it should be understood that each of the descriptions is copyrighted material owned by the inventor of this application.

Although a preferred embodiment of this invention has been disclosed, a worker in this art would recognize that various modifications would come within the scope of this invention. For that reason, the following claims should be studied to determine the true scope and content of this invention.

1. A method for grouping patients comprising the steps of:
1) analyzing the patient and reaching an evaluation in each of several scales;
2) grouping an analyzed patient into one of several groups based upon an evaluation of the rankings in the scales, and utilizing a hierarchy for the scales to perform the grouping.

2. A method as set forth in claim 1, wherein the grouping of step 2 occurs by evaluating the rankings in a fashion such that if a particular scale is associated with a particularly severe ranking, then a grouping is made based upon the severe ranking.

3. A method as set forth in claim 2, wherein a scale related to the ability to think is utilized as the first scale to be evaluated, and if substantial problems are determined with regard to the thinking scale, then the patient is categorized with a group associated with thinking problems.

4. A method as set forth in claim 3, wherein results of the thinking scale are not high, the next scale evaluated is a substance use scale, and if the substance use scale has a particularly high ranking, then the patient is grouped into a substance use group.

5. A method as set forth in claim 1, wherein once a particular group has been identified for a patient, questions are asked with regard to the family or home of the patient to identify a recommended intensity of treatment.

6. A tool for ranking patients comprising:
a flowchart for evaluating scores in several scales, said scales at least including a scale relating to a patient's ability to think, a patient's substance use history, and a patient's self-harmful behavior, said flowchart applying the scales in a hierarchy, and moving the patient into being placed in any one of a plurality of groups while moving through said hierarchy of scales, if a particular scale is associated with a ranking above a particular value.

7. A tool as recited in claim 6, wherein said flowchart is incorporated into a software program in a computer.

8. A tool as recited in claim 6, wherein said flowchart is incorporated into paper form.

9. A tool as recited in claim 6, wherein additional questions are asked with regard to the family or home for the particular patient, based upon the identified group, and recommendations are made, in part, based upon the family or home of the patient.

10. A tool as recited in claim 6, wherein once a group has been identified, further questions with regard to the patient's environment are asked to identify recommended care.

11. A method of associating patients with a particular group comprising the steps of:
1) performing a CAFAS evaluation on a patient to identify scores in at least the thinking scale, the substance use scale and the self-harmful behavior scale;
2) evaluating the identified CAFAS scores through a flowchart that asks whether the thinking scale is above a particular value, and if said thinking scale is above said particular value grouping the patient into a thinking tier, and if the thinking scale is below a particular value, next asking whether the substance use score is above a particular value;
3) if the substance use score is above a particular value, grouping the patient into a substance use grouping; and
4) if the substance use score is below a particular value, next asking whether the self-harmful score is above a particular value, and grouping the patient into a self-harmful group, if the self-harmful group score is above a particular value.

12. A method as set forth in claim 11, wherein if a mood/emotion score is also above a particular value, grouping the patient into the self-harm group.

13. A method as set forth in claim 11, wherein if both self-harmful and mood/emotion are below a particular value, next evaluating the patient's community score, and if the community score is above a particular value, grouping the patient into an uncomplicated delinquent group.

14. A method as set forth in claim 10, wherein once a particular group has been identified for a patient, questions are asked with regard to the family or home of the patient to identify a recommended intensity of treatment.
